(19) United States
(12) Patent Application Publication
(10) Pub. No.: US 2011/0010972 A1
(43) Pub. Date: Jan. 20, 2011

(54) Lockable menu board device and method

(76) Inventors: Patricia Venetucci, Hawthorn Woods, IL (US); Lawrence Labedz, Naperville, IL (US)

Correspondence Address: RYNDAK & SURI LLP, 200 W. MADISON STREET, SUITE 2100, CHICAGO, IL, 60606, US

(21) Appl. No.: 12/460,195

(22) Filed: Jul. 15, 2009

(51) Int. Cl. G09F 11/02; G09F 13/00

(52) U.S. Cl. 40/502; 40/504

(57) ABSTRACT

A menu display device having a plurality of rotatable multiple-sided display members is provided. The displays are independently rotatable to a desired side and have a locking mechanism that prevents unauthorized rotation of the multiple-sided display member.

### TECHNICAL FIELD

The invention relates to a lockable menu board device and method. More particularly, it relates to menu board display devices having a plurality of rotatable multi-face displays having associated locking mechanisms to prevent unauthorized manipulation of the menu displays.

### BACKGROUND OF THE INVENTION

Outdoor signs and display devices are commonly in use for many purposes today, particularly for presenting advertising and promotional materials relative to various businesses. Quick-service restaurants in particular use signs on their premises adjacent to pathways leading to the restaurant or along their vehicle drive-through service lanes. The devices are used to display various menu items and/or to provide information and prices for consumers. In addition, seasonal promotions and other “specials” are often promoted by these devices.

Changes to the displayed information frequently need to be made due to advertising needs, customer demand, menu changes, pricing changes, or for other reasons. Because the items offered can change on short notice, it is desirable to have a display that can be easily changed and then locked back into position. It is also desirable to have a sign display with multiple sides, to allow changes in the display without having to install a new display unit.

It is also important for outdoor signs to have security procedures of some type so that the messages and pricing materials on the signs cannot be readily tampered with, vandalized or manipulated in an unauthorized manner. At the same time, it is also necessary to allow frequent and easy access to the displays by authorized personnel in order to change the promotional items or add additional current items. It would be desirable to have the displays be independently rotatable and independently lockable or cooperatively lockable, to allow greater flexibility in designing, changing and securing the display.

It is not uncommon for an outside agency, such as, for example, an unauthorized person or excessive wind, to move the rotatable sign. For example, a child or other person may reach through a car window and move the sign as the car is going through the drive-thru. The sign could also be moved by persons on foot or on bicycle, for example. The sign is especially at risk when the restaurant is closed, and there are fewer lights and no one is around to watch. Also, high winds (such as from severe weather) can occur and could move the sign out of place. Thus, a need exists for a device that prevents the rotation of the sign by people or other outside forces, but still allows authorized personnel to readily change the display.

It is desirable that the locking mechanism be readily accessible by authorized personnel, but not to others. For example, the locking mechanism can be hidden from plain sight by disguising its function or by hiding the locking mechanism inside or under the frame.

It is desirable to have the display panels organized in the menu board frame to maximize the viewing area. It is also desirable to align the displays to better attract the customers' attention and reduce glare. For example, the display panels can be generally flat, or have the ends angled slightly inward and forward.

### SUMMARY OF THE INVENTION

The present invention provides an apparatus for displaying indicia. The display may be divided into a number of sections for displaying the indicia, such as advertisements, promotional material, or a menu. The apparatus for display includes a frame and a plurality of shafts mounted on the frame. The frame helps protect the displays from the weather and other outside forces.

Each display has a plurality of sides, and each side is paired for display at the same time with at least one side of at least one other display.

One or more quick release locks are attached to each display. The quick release lock only prevents the rotation of the display it is attached to. Preferably hidden from the customer, the quick release lock allows the rotation or changing of the displays. The quick release locks also help prevent unauthorized people or other outside people from changing or rotating the display out of the desired position.

The displays are rotatably mounted on each shaft, and rotate independently of the other displays. This allows greater flexibility in the rotation and changing of the displays. For example, some displays can be held in place while others are rotated during a display changeover (e.g., breakfast to lunch, lunch to dinner, dinner to late night). The independent displays may also be switched out with a new display.

The displays may have lights to enable the indicia to be more easily seen. For example, there could be a vertical or horizontal fluorescent light in each display. If the lights are inside the display, the displays should be made of partially transparent or translucent material so that light can pass through them. However, portions of the frame around the display may not be translucent or transparent to allow for contrast to attract a viewer's attention when it is dark.

### BRIEF DESCRIPTION OF THE DRAWINGS

FIG. 1 is a front perspective view illustrating a menu display device in accordance with the present invention;

FIG. 2 is a front elevation view of the menu display device of FIG. 1;

FIG. 3 is a side elevation view of the menu display device of FIG. 1 with the vertical sides removed;

FIG. 4 is a top plan view of the menu display device of FIG. 1;

FIG. 5 is an enlarged fragmentary front elevation view of the bottom right portion of the menu display device of FIG. 1;

FIG. 6 is a rear perspective view illustrating an alternate embodiment of a menu display device in accordance with the present invention;

FIG. 7 is an enlarged fragmentary perspective rear view of the menu display device of FIG. 6; and

FIG. 8 is an enlarged fragmentary perspective view of a portion of the menu display device of FIG. 6.

### DETAILED DESCRIPTION OF THE INVENTION

While this invention is susceptible of embodiment in many different forms, there is shown in the drawings and described in detail herein, several specific embodiments with the understanding that the present disclosure is to be considered as exemplifications of the principles of the invention and is not intended to limit the invention to the embodiments illustrated.

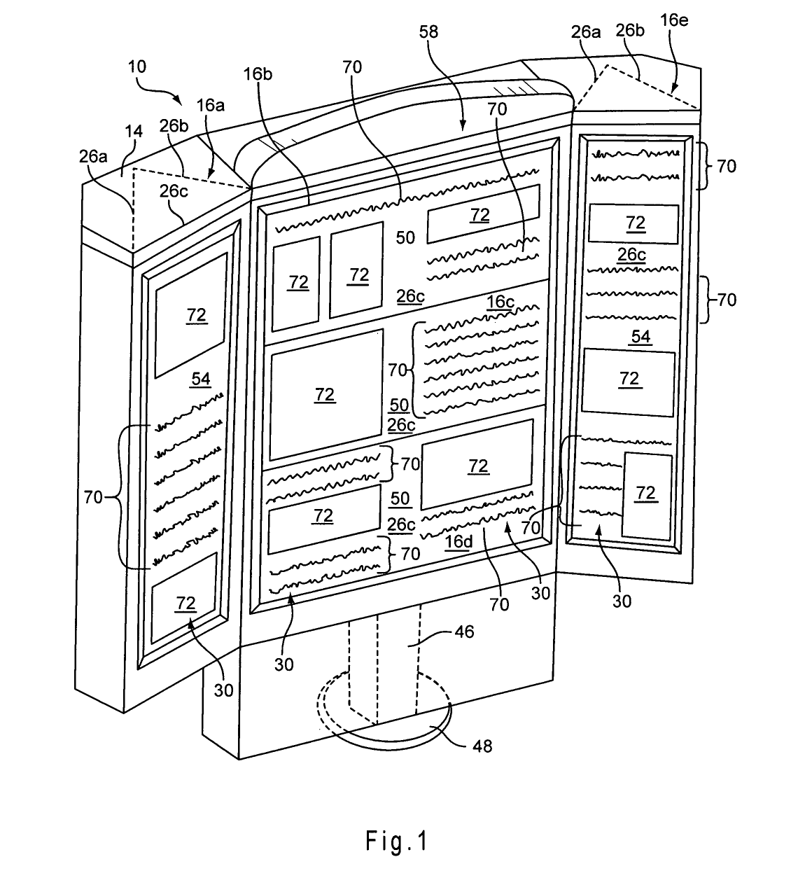

In one embodiment, the apparatus for display is a menu board 10, as seen in FIGS. 1-5. Menu board 10 is composed of a frame 14 having a plurality of triangular menu displays 16a-e mounted thereto. Triangular menu displays 16a-e are each mounted for rotation to frame 14 about a respective shaft 18a-e carried by frame 14. Triangular menu displays 16a-e are rotatable independently of each other. As illustrated, each triangular menu display 16a-e has three sides 26a-c for displaying desired indicia 30. One side 26a-c of each of triangular menu displays 16a-e is displayed at a time on menu board 10. It is to be understood that the present invention is applicable to and includes indicia displays that are mounted for rotation having two, four, five or more sides, in addition to the three-sided (triangular) embodiment described in detail herein. It is also understood that the indicia may be any human-readable indicia, not limited to menu-related indicia. One of sides 26a-c being displayed can be changed by rotating triangular menu displays 16a-e as desired, or by replacing one of triangular menu displays 16a-e with another one of triangular menu displays 16a-e. Typically, a selected one of sides 26a-c will be displayed for each of triangular menu displays 16a-e. One of sides 26a-c may relate to breakfast, lunch and dinner menu items, respectively. As seen in FIG. 1, sides 26 that have dotted lines show the location of non-displayed sides for triangular menu displays 16a-e with three sides.

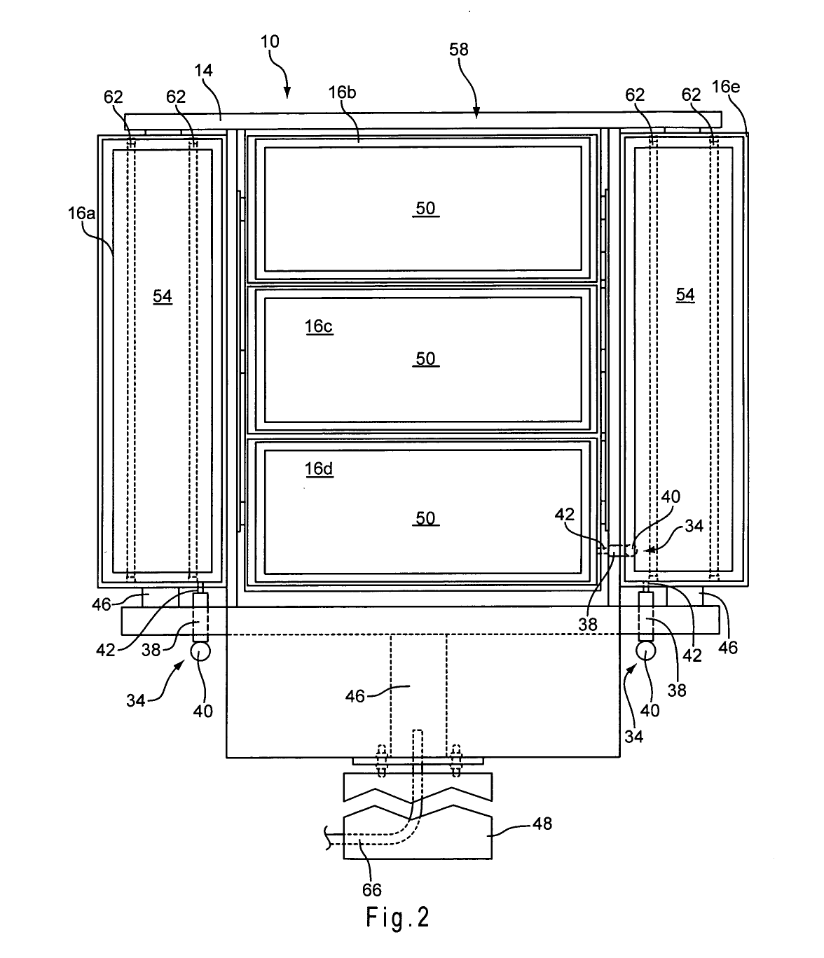

Each triangular menu display 16a-e also has a locking mechanism which may be one of several types as described herein. For example, a quick release locking mechanism 34 may be provided that prevents the unauthorized rotation of triangular menu displays 16a-e by people or other outside forces. Each quick release locking mechanism 34 is dedicated to a specific one of displays 16a-e. Each quick release locking mechanism 34 will typically only be activated by authorized personnel at the proper time intervals for changing triangular menu displays 16a-e (e.g., for breakfast, lunch and dinner), and thus preferably each is located in a location that is unobtrusive and not readily visible to persons viewing menu board 10, as shown in FIGS. 2, 4 and 5. Quick release locking mechanism 34 can be of any suitable type, but preferably includes a locking pin assembly 38. Quick release locking mechanism 34 could also be a lever lock, bicycle type lock, cam lock, child safety lock, combination lock, cruciform (or Zeiss) lock, cylinder lock, deadbolt, disc tumbler lock, electronic lock, electric strike, magnetic lock, keycard lock, lever tumbler lock, Chubb detector lock, protector lock, magnetic keyed lock, padlock, pin tumbler lock, rim lock, tubular pin tumbler lock, time lock, Turner lock, wafer tumbler lock, Warded lock or any combination thereof.

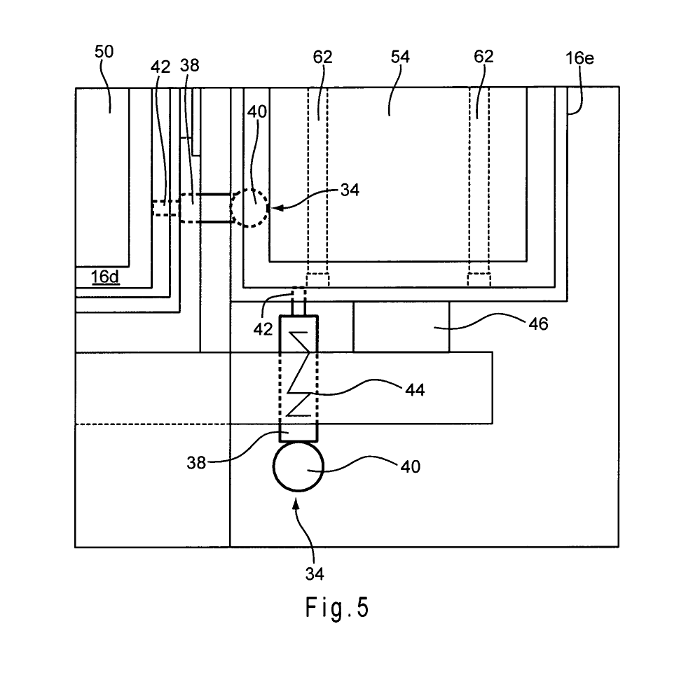

FIG. 5 shows an enlarged view of one embodiment of menu board 10, and includes an enlarged view of locking pin assembly 38. In this embodiment, a locking pin 40 is removably inserted into a locking hole 42 to lock triangular menu display 16e in place, after triangular menu display 16e has been rotated to the desired position. A biasing member 44, such as a spring, biases and maintains locking pin 40 in locking hole 42 in triangular menu display 16e, until sufficient force is applied to withdraw locking pin 40 from locking hole 42, allowing triangular menu display 16e to be rotated to a different position so as to display a different one of sides 26a-c. Biasing member 44 functions as a positive lock by urging locking pin 40 into locking hole 42. In this manner, the positive locking action of quick release locking mechanism 34 keeps locking pin 40 from unintentionally moving to an unlocked position.

A locking hole is provided for each face of the display. Thus, for a three-sided triangular menu display 16, three locking holes 42 in display 16 would be provided, preferably spaced every 120 degrees. For a two-sided triangular display (not shown), two locking holes would be provided, preferably spaced every 180 degrees. For example, when it is time to change triangular menu display 16a, locking pin 40 is pulled out of locking hole 42 to allow triangular menu display 16a to be turned. A triangular menu display 16a is then rotated to the next desired position. Typically, each of triangular menu displays 16a-e is matched for a particular time period. Depending on the indicia or menu items, some triangular menu displays 16a-e may not be rotated for a different time period. After triangular menu display 16a is moved to the next desired position, locking pin 40 is put back in place to prevent undesired or unauthorized movement of triangular menu display 16a.

In one embodiment, there are five triangular menu displays 16a-e mounted on frame 14. Frame 14 can be secured by a suitable support, in this case a tubular support 46 anchored in or to the ground and may rest on a foundation 48. Tubular support 46 can be further secured by a foundation 48 made of concrete or other suitable materials. In one example pictured in FIGS. 1-4, there are three three-sided horizontal displays 16b-d and two three-sided vertical displays 16a,e mounted on frame 14. Various combinations of rotatable horizontal and/or vertical triangular menu displays can be utilized as desired and it will be appreciated that not all of the displays need to be of the same dimensions or of the same number of display panels.

As shown in FIGS. 1-4, there is at least one vertical wing display 54 on each side of a central tower module 58. Central tower module 58 contains horizontal displays 50 stacked on top of each other. Preferably, the same number of vertical wing displays 54 are on each side of central tower module 58. Vertical wing displays 54 can be in line with central tower module 58 or angled forward or backward from central tower module 58. Preferably, the ends of vertical wing displays 54 both can be angled from about −20 to 20 degrees or as otherwise desired and typically will be angled the same amount on both sides of central tower module 58. In one embodiment, vertical wing displays 54 on both ends are angled about 7 degrees from central tower module 58, which provides a good viewing perspective for a customer located a spaced distance from approximately the center of central tower module 58.

For this embodiment, triangular menu displays 16a-e can be made of an aluminum extrusion triangular frame rotatably mounted on shafts 18a-e. As seen in FIGS. 1-5, triangular menu displays 16a-e may also contain a light fixture 62 that preferably faces toward indicia 30 desired to be displayed. Preferably, there is only one light fixture 62 for each triangular menu display 16a-e. Preferably, the light fixture is stationary and sides 26 of triangular menu displays 16a-e rotate around light fixture 62. Light fixture 62 can be of any type, but preferably light fixture 62 is a fluorescent light. Light fixture 62 could also be an arc lamp, a gas discharge lamp, an LED lamp, an incandescent lamp, or combinations thereof.

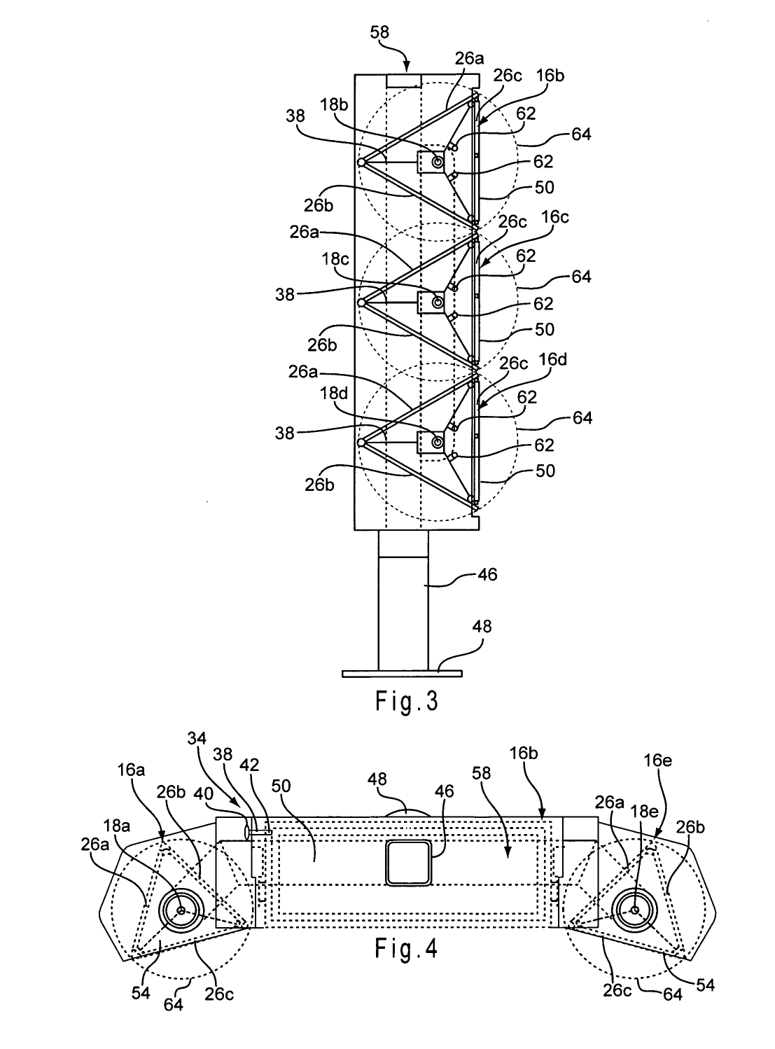

As seen in FIGS. 3 and 4, a rotation path 64 shows the path of the outermost points of triangular menu displays 16a-e as triangular menu displays 16a-e rotate. Preferably, rotation path 64 prevents triangular menu displays 16a-e from rubbing up against frame 14 or other triangular menu displays 16a-e. It is also desirable that rotation path 64 does not interfere with the locking and unlocking of quick release locking mechanism 34.

As seen in FIG. 2, a power supply line 66 may be installed through foundation 48 and into tubular support 46 to supply power to menu board 10. Power supply line 66 may also contain wires to carry electronic control and/or data signals to and from menu board 10. Power supply line 66 may also carry wires to carry voice signals to and from menu board 10.

Indicia 30 can be in any human-readable form able to communicate information to a customer or other observer. For example, indicia 30 can include character indicia 70, graphical indicia 72, or combinations thereof, as seen in FIG. 1. Character indicia 70 can include symbols, numbers, punctuation, blank spaces and/or Braille characters. Graphical indicia 72 can include photos, illustrations, diagrams, trademarks and/or designs. Triangular menu displays 16a-e could also include some sort of screen or television to indicia 30. Audio could also be used to supplement the information of indicia 30.

As seen in FIG. 1, the invention also includes a method for displaying indicia. The indicia are displayed on a plurality of independently rotatable displays 16a-e. For example, the entirety of a restaurant menu could be displayed on five displays 16a-e. The independent locks attached to each display remain engaged when not desiring to change any of displays 16a-e. After the desired time interval has passed or it is otherwise desired to change the position of any of displays 16a-e, the locks of displays 16a-e desired to be rotated at this time are disengaged. However, the remaining locks of displays 16a-e remain engaged. For example, displays 16a-e that do not need to be changed for the next time period would remain engaged and thus would not change at that time.

Displays 16a-e that need to be rotated at this time are rotated to the desired position. After the desired displays are changed, the independent locks of the changed displays are re-engaged to prevent rotation of the displays. After the desired time interval has passed, the process begins again. For example, the process could be done continuously for a 24-hour restaurant. However, in general the process will end when the business closes. Preferably, all of the locks will be engaged when the business is closed to prevent tampering or undesired rotation by people, weather or other outside forces.

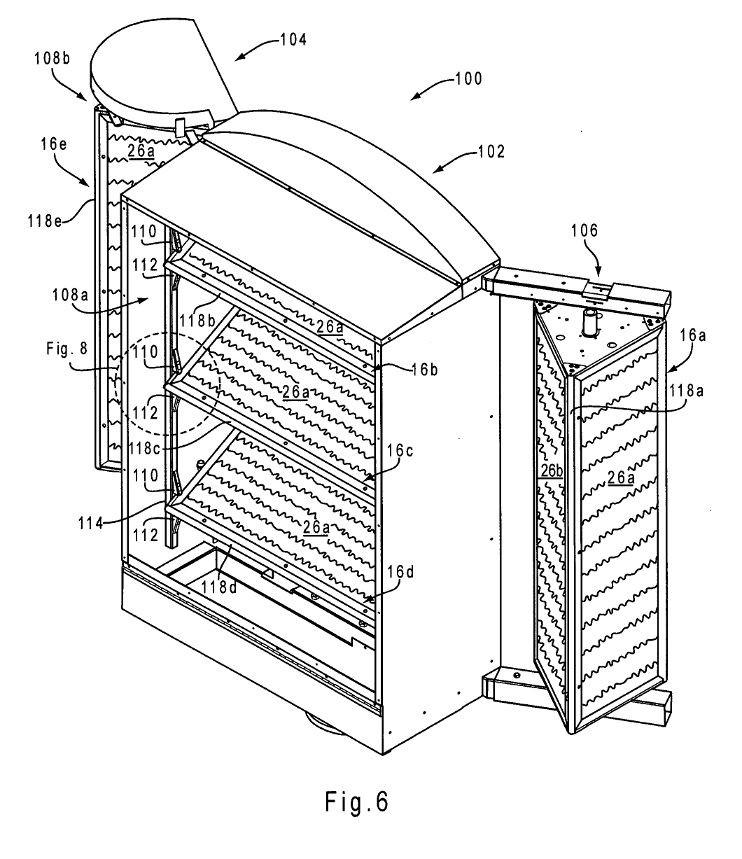

Referring to FIGS. 6-8, there is illustrated another embodiment of a menu board device 100 in accordance with the invention. Menu board device 100 is composed of three display sections, a central horizontal display 102 and two vertical wing displays 104 and 106. Menu board device 100 is similar in appearance and construction to menu board 10, and thus like reference numerals denote like elements, except for the nature of the locking mechanism of FIG. 1. Consequently, FIG. 6 is a rear perspective view of menu board device 100.

Menu board device 100 includes locking mechanisms 108a and 108b that are suitable for locking a single one of triangular menu displays 16a-e, such as triangular menu displays 16a and 16e, or a plurality of menu displays 16b-d. Locking mechanisms 108a and 108b are positive locking mechanisms that when in a locked position prevent rotation of menu displays 16a-e, such as illustrated in FIGS. 6-8.

Locking mechanism 108a as illustrated is composed of opposed locking tabs 110 and 112 for each of triangular menu displays 16b-d mounted in a spaced relation on an arm 114. The spaced relation defines a gap 116 in which a triangular corner 118b-d of each of triangular menu displays 16b-d, respectively, is disposed when triangular menu displays 16b-d are in a locked position for displaying side 26c of triangular menu displays 16b-d as shown in FIG. 6.

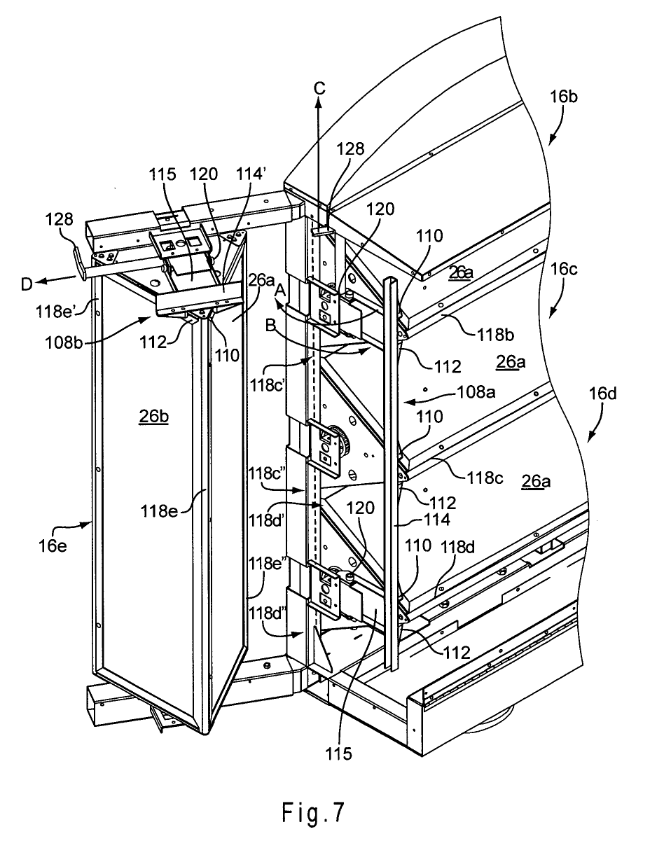

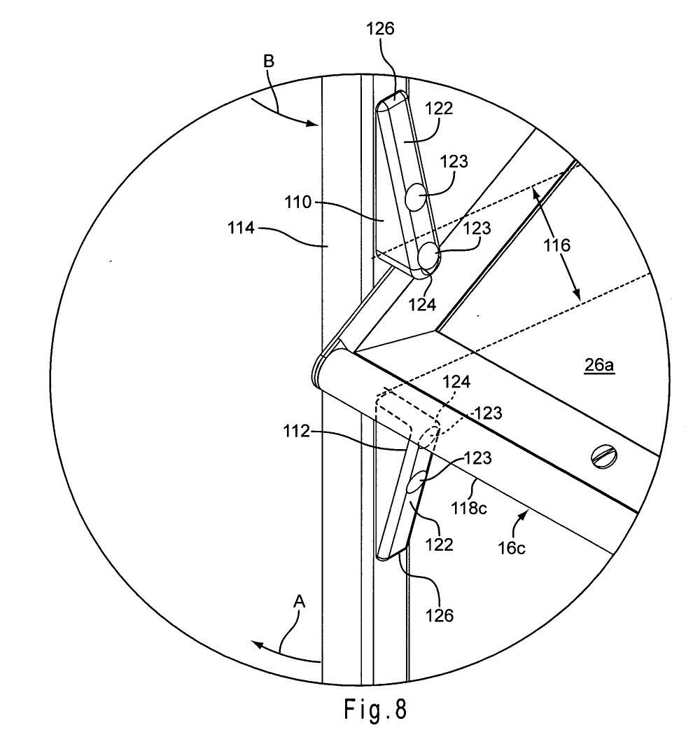

Arm 114 is mounted for pivotal movement about pins 120 with respect to frame 14 and triangular menu displays 16b-d by support members 115. Support members 115 may be J-shaped to allow pins 120 to be disposed therein as shown in FIG. 7. This allows arm 114 and locking tabs 110 and 112 to be pivoted away from triangular menu displays 16b-d, such as in the direction of arrow A in FIGS. 7 and 8 to cause them to be unlocked, allowing them to be manually rotatable to allow placement on a different one of sides 26a-c in a display position facing the front of menu board device 100 as illustrated in FIG. 1 as desired. A retractable stop member 128 can be included as part of locking mechanisms 108a and 108b. Retractable stop member 128 adjacent pin 120 prevents pivoting movement of arms 114, 114′ about pin 120. Retracting stop member 128 in the direction of arrows C and D from being adjacent pin 120 allows pivotal movement of arms 114 and 114′ about respective pins 120. After moving one or more of sides 26a-c to a different position, arm 114 can be pivoted towards triangular menu displays 16b-d in the direction of arrow B as shown in FIGS. 7 and 8 to place a desired one of triangular corners 118b-d, 118b′-d′ and 118b″-d″ in gap 116 to thereby lock displays 16b-d in a desired position. A selected one of triangular corners 118a,e, 118a′,e′ and 118a″, e″ of displays 16a, 16e can also be placed in gap 116 of locking mechanism 108b of displays 16a and 16e. Locking mechanisms 108b of displays 16a and 16e are similar to locking mechanisms 108a except that arms 114′ of locking mechanism 108b are shorter and are configured to lock a single display 16a or 16e. Locking mechanism 108b is not shown for display 16a in FIG. 6.

Each of opposed locking tabs 110, 112 is secured to arm 114, 114′ in any suitable manner, such as by rivets 123, nuts and bolts, screws, adhesive or they may be formed as an integral part of arms 114 and 114′, for example.

Each of opposed locking tabs 110, 112 is configured in the illustrated embodiment as an inclined ramp 122 with the upper portion 124 of the ramp terminating at gap 116. Arms 114 and 114′ may be rigid or can have some flexibility so that the corner of triangular corners 118a-e can initially contact a lower portion 126 of respective inclined ramp 122 and traverse ramp 122 until the respective triangular corner 118a-e is located within gap 116. Respective arms 114, 114′ can flex away from triangular corners 118a-e to permit such traverse. Alternatively, arms 114, 114′ can be mounted to pins 120 to permit some lateral movement and traverse of corners 118a-e along respective ramp 122. When a respective one of triangular corners 118a-e clears the top of ramp 122 it can abruptly fall into gap 116 and give an audible and tactile indication of being locked in position.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. An apparatus for displaying indicia, comprising:
a frame;
a plurality of shafts mounted on the frame;
a plurality of displays, rotatably mounted on each shaft, wherein each display rotates independently of the other displays;
each display having a plurality of sides, wherein each side is paired for display at the same time with at least one side of at least one other display; and
at least one quick release locking mechanism attached to each display, wherein each locking mechanism only stops or allows the rotation of one display.

2. The apparatus for displaying indicia of claim 1, wherein the quick release locking mechanism constantly exerts force against the frame to keep the display in position.

3. The apparatus for displaying indicia of claim 1, wherein the quick release locking mechanism includes a locking pin assembly.

4. The apparatus for displaying indicia of claim 3, wherein the locking pin assembly includes a locking pin being biased into a locking hole by a biasing member.

5. The apparatus for displaying indicia of claim 1, further comprising a tubular support on which the frame is mounted.

6. The apparatus for displaying indicia of claim 4, further comprising a foundation to which the tubular support is secured.

7. The apparatus for displaying indicia of claim 1, further comprising a light fixture.

8. A method for displaying indicia, comprising:
displaying indicia on a plurality of independently rotatable display members, each having a plurality of sides;
engaging independent locking mechanisms attached to each display member when not rotating the display members;
disengaging locking mechanisms of the display members to be rotated after a desired time interval has passed;
repositioning the display members to the next position; and thereafter
re-engaging the opened independent locking mechanisms to prevent rotation of the display members.

9. The method for displaying indicia of claim 8, wherein the sides of each of the display members are positioned such that all the sides paired for display at the same time are displayed together at the desired time.

10. The method for displaying indicia of claim 8, wherein the sides are repositioned at least three times per day.

11. The method for displaying indicia of claim 8, wherein each locking mechanism is constantly exerting a force against its respective display member to keep the display member in the locked position.

12. The method for displaying indicia of claim 8, wherein the indicia are menu indicia.

13. The method for displaying indicia of claim 8, wherein the sides are repositioned by rotating by a whole number multiple of (360/number of sides on the display) degrees.

14. An apparatus for displaying indicia, comprising:
a frame;
a plurality of shafts mounted on the frame;
a plurality of displays, rotatably mounted on each shaft, wherein each display rotates independently of the other displays;
each display having a plurality of sides, wherein each side is paired for display at the same time with at least one side of at least one other display;
a central tower module having a plurality of horizontal displays, wherein the central tower module has at least one vertical display disposed at each end of the central tower module; and
at least one quick release locking mechanism attached to each display, wherein each locking mechanism only stops or allows the rotation of one display.

15. The apparatus for displaying indicia of claim 14, wherein the vertical displays are angled toward the center of the central tower module.

16. The apparatus for displaying indicia of claim 15, wherein the vertical displays are angled between about −20 and about 20 degrees from the central tower module.

17. The apparatus for displaying indicia of claim 14, wherein the quick release locking mechanism constantly exerts force against the frame to keep the display in position.

18. The apparatus for displaying indicia of claim 14, wherein the quick release locking mechanism includes a locking pin assembly.

19. The apparatus for displaying indicia of claim 18, wherein the locking pin assembly includes a locking pin being biased into a locking hole by a biasing member.

20. The apparatus for displaying indicia of claim 14, further comprising a tubular support on which the frame is mounted.
